(19) United States
(12) Patent Application Publication
(10) Pub. No.: US 2010/0325128 A1
(43) Pub. Date: Dec. 23, 2010

(54) GENERATING AND REGISTERING DOMAIN NAME-BASED SCREEN NAMES

(75) Inventors: Warren Adelman, Scottsdale, AZ (US); Justin Jilg, Mesa, AZ (US)

Correspondence Address: GO DADDY GROUP, INC., 14455 NORTH HAYDEN ROAD, SUITE 219, SCOTTSDALE, AZ, 85260, US

(73) Assignee: THE GO DADDY GROUP, INC., Scottsdale, AZ (US)

(21) Appl. No.: 12/487,555

(22) Filed: Jun. 18, 2009

(51) Int. Cl. G06F 7/06; G06F 17/30; G06F 15/16

(52) U.S. Cl. 707/759; 709/203; 707/769; 707/770; 707/803; 707/812

(57) ABSTRACT

Methods of the present inventions allow for generating and registering domain name-based screen names. An exemplary method may comprise the steps of registering a domain name to a registrant, generating a screen name for a software application that may be based upon the domain name, and registering the screen name to the registrant.

### CROSS REFERENCE TO RELATED PATENT APPLICATIONS

This patent application is related to U.S. patent application Ser. No. ______ entitled: “Generating and Registering Screen Name-Based Domain Names” concurrently filed herewith and also assigned to The Go Daddy Group, Inc.

### FIELD OF THE INVENTION

The present inventions generally relate to domain name registration and, more particularly, methods for generating and registering domain name-based screen names and screen name-based domain names.

### SUMMARY OF THE INVENTION

An example embodiment of a method for generating and registering domain name-based screen names may comprise the steps of registering a domain name to a registrant, generating a screen name for a software application that may be based upon the domain name, and registering the screen name to the registrant.

An example embodiment of a method for generating and registering screen name-based domain names may comprise the steps of registering a screen name for a software application to a registrant, generating a domain name that may be based upon the screen name, and registering the domain name to the registrant.

The features and advantages of the present inventions will be better understood from the following detailed description taken in conjunction with the accompanying drawings.

### BRIEF DESCRIPTION OF THE DRAWINGS

FIG. 1 is a flow diagram illustrating a possible embodiment of a method for generating and registering domain name-based screen names.

FIG. 2 is a flow diagram illustrating a possible embodiment of a method for generating and registering domain name-based screen names.

FIG. 3 is a flow diagram illustrating a possible embodiment of a method for generating and registering domain name-based screen names.

FIG. 4 is a flow diagram illustrating a possible embodiment of a method for generating and registering domain name-based screen names.

FIG. 5 is a flow diagram illustrating a possible embodiment of a method for generating and registering domain name-based screen names.

FIG. 6 is a flow diagram illustrating a possible embodiment of a method for generating and registering domain name-based screen names.

FIG. 7 is a flow diagram illustrating a possible embodiment of a method for generating and registering domain name-based screen names.

FIG. 8 is a flow diagram illustrating a possible embodiment of a method for generating and registering domain name-based screen names.

FIG. 9 is a flow diagram illustrating a possible embodiment of a method for generating and registering screen name-based domain names.

FIG. 10 is a flow diagram illustrating a possible embodiment of a method for generating and registering screen name-based domain names.

FIG. 11 is a flow diagram illustrating a possible embodiment of a method for generating and registering screen name-based domain names.

FIG. 12 is a flow diagram illustrating a possible embodiment of a method for generating and registering screen name-based domain names.

FIG. 13 is a flow diagram illustrating a possible embodiment of a method for generating and registering screen name-based domain names.

FIG. 14 is a flow diagram illustrating a possible embodiment of a method for generating and registering screen name-based domain names.

FIG. 15 is a flow diagram illustrating a possible embodiment of a method for generating and registering screen name-based domain names.

FIG. 16 is a flow diagram illustrating a possible embodiment of a method for generating and registering screen name-based domain names.

FIG. 17 illustrates a system that may be used for generating and registering screen name-based domain names and/or domain name-based screen names.

### DETAILED DESCRIPTION

The present inventions will now be discussed in detail with regard to the attached drawing figures which were briefly described above. In the following description, numerous specific details are set forth illustrating the Applicant's best mode for practicing the inventions and enabling one of ordinary skill in the art to make and use the inventions. It will be obvious, however, to one skilled in the art that the present inventions may be practiced without many of these specific details. In other instances, well-known machines, structures, and method steps have not been described in particular detail in order to avoid unnecessarily obscuring the present inventions. Unless otherwise indicated, like parts and method steps are referred to with like reference numerals.

A network is a collection of links and nodes (e.g., multiple computers and/or other devices connected together) arranged so that information may be passed from one part of the network to another over multiple links and through various nodes. Examples of networks include the Internet, the public switched telephone network, the global Telex network, computer networks (e.g., an intranet, an extranet, a local-area network, or a wide-area network), wired networks, and wireless networks.

The Internet is a worldwide network of computers and computer networks arranged to allow the easy and robust exchange of information between computer users. Hundreds of millions of people around the world have access to computers connected to the Internet via Internet Service Providers (ISPs). Content providers place multimedia information (e.g., text, graphics, audio, video, animation, and other forms of data) at specific locations on the Internet referred to as webpages. Websites comprise a collection of connected, or otherwise related, webpages. The combination of all the websites and their corresponding webpages on the Internet is generally known as the World Wide Web (WWW) or simply the Web.

For Internet users and businesses alike, the Internet continues to be increasingly valuable. More people use the Web for everyday tasks, from social networking, shopping, banking, and paying bills to consuming media and entertainment. E-commerce is growing, with businesses delivering more services and content across the Internet, communicating and collaborating online, and inventing new ways to connect with each other.

Prevalent on the Web are multimedia websites, some of which may offer and sell goods and services to individuals and organizations. Websites may consist of a single webpage, but typically consist of multiple interconnected and related webpages. Websites, unless extremely large and complex or have unusual traffic demands, typically reside on a single server and are prepared and maintained by a single individual or entity. Menus and links may be used to move between different webpages within the website or to move to a different website as is known in the art. The interconnectivity of webpages enabled by the Internet can make it difficult for Internet users to tell where one website ends and another begins.

Websites may be created using HyperText Markup Language (HTML) to generate a standard set of tags that define how the webpages for the website are to be displayed. Users of the Internet may access content providers' websites using software known as an Internet browser, such as MICROSOFT INTERNET EXPLORER or MOZILLA FIREFOX. After the browser has located the desired webpage, it requests and receives information from the webpage, typically in the form of an HTML document, and then displays the webpage content for the user. The user then may view other webpages at the same website or move to an entirely different website using the browser.

Some Internet users, typically those that are larger and more sophisticated, may provide their own hardware, software, and connections to the Internet. But many Internet users either do not have the resources available or do not want to create and maintain the infrastructure necessary to host their own websites. To assist such individuals (or entities), hosting companies exist that offer website hosting services. These hosting providers typically provide the hardware, software, and electronic communication means necessary to connect multiple websites to the Internet. A single hosting provider may literally host thousands of websites on one or more hosting servers.

Browsers are able to locate specific websites because each website, resource, and computer on the Internet has a unique Internet Protocol (IP) address. Presently, there are two standards for IP addresses. The older IP address standard, often called IP Version 4 (IPv4), is a 32-bit binary number, which is typically shown in dotted decimal notation, where four 8-bit bytes are separated by a dot from each other (e.g., 64.202.167.32). The notation is used to improve human readability. The newer IP address standard, often called IP Version 6 (IPv6) or Next Generation Internet Protocol (IPng), is a 128-bit binary number. The standard human readable notation for IPv6 addresses presents the address as eight 16-bit hexadecimal words, each separated by a colon (e.g., 2EDC:BA98:0332:0000:CF8A:000C:2154:7313).

IP addresses, however, even in human readable notation, are difficult for people to remember and use. A Uniform Resource Locator (URL) is much easier to remember and may be used to point to any computer, directory, or file on the Internet. A browser is able to access a website on the Internet through the use of a URL. The URL may include a Hypertext Transfer Protocol (HTTP) request combined with the website's Internet address, also known as the website's domain name. An example of a URL with a HTTP request and domain name is: http://www.companyname.com. In this example, the “http” identifies the URL as a HTTP request and the “companyname.com” is the domain name.

Domain names are much easier to remember and use than their corresponding IP addresses. The Internet Corporation for Assigned Names and Numbers (ICANN) approves some Generic Top-Level Domains (gTLD) and delegates the responsibility to a particular organization (a “registry”) for maintaining an authoritative source for the registered domain names within a TLD and their corresponding IP addresses. For certain TLDs (e.g., .biz, .info, .name, and .org) the registry is also the authoritative source for contact information related to the domain name and is referred to as a “thick” registry. For other TLDs (e.g., .com and .net) only the domain name, registrar identification, and name server information is stored within the registry, and a registrar is the authoritative source for the contact information related to the domain name. Such registries are referred to as “thin” registries. Most gTLDs are organized through a central domain name Shared Registration System (SRS) based on their TLD.

The process for registering a domain name with .com, .net, .org, and some other TLDs allows an Internet user to use an ICANN-accredited registrar to register their domain name. For example, if an Internet user, John Doe, wishes to register the domain name “mycompany.com,” John Doe may initially determine whether the desired domain name is available by contacting a domain name registrar. The Internet user may make this contact using the registrar's webpage and typing the desired domain name into a field on the registrar's webpage created for this purpose. Upon receiving the request from the Internet user, the registrar may ascertain whether “mycompany.com” has already been registered by checking the SRS database associated with the TLD of the domain name. The results of the search then may be displayed on the webpage to thereby notify the Internet user of the availability of the domain name. If the domain name is available, the Internet user may proceed with the registration process. If the domain name is not available for registration, the Internet user may keep selecting alternative domain names until an available domain name is found.

Social websites may comprise Internet-based social networking services that focus on building and verifying online social networks for communities of people who may share interests and activities, wish to communicate with each other efficiently, and may be interested in exploring the interests and activities of others, and which necessitates the use of software applications. Most social websites are Internet based and provide a collection of various ways for users to interact, such as micro-blogging, blogging, chat, forums, instant messaging, email, video, voice chat, file sharing, discussion groups, etc. The main types of social networking services are those that contain directories of some categories (such as former classmates), means to connect and communicate with friends, and/or recommendation systems linked to trust. Popular social websites now combine many of these, with TWITTER, MYSPACE, FACEBOOK, YOUTUBE, LINKEDIN, and FLICKR being but a few examples. Many Internet users use “screen names” as a means of identification on such social websites, perhaps after being authenticated.

Applicant has noticed that domain names are increasingly the anchor around which an Internet user's online presence is maintained. For example, a company's website (www.mycompany.com) and email system (john.doe@mycompany.com) utilize the company's domain name as an integral part of their architecture. Similarly, many Internet users use their email address, and therefore their domain name, as a means of identification on social websites. Internet users who utilize social networking sites (or other software applications) requiring a screen name for purposes of identification also may wish to integrate their domain name (or some variant of it) into their screen name. Similarly, screen name holders (perhaps because their screen name has become well known) may wish to register a matching (or related) domain name.

Applicant has therefore determined that presently-existing methods do not provide adequate means for generating and registering domain name-based screen names or screen name-based domain names. For these reasons, there is a need for the methods for generating and registering domain name-based screen names and screen name-based domain names (and related functionality) as described herein.

Methods for Generating and Registering Domain Name-Based Screen Names

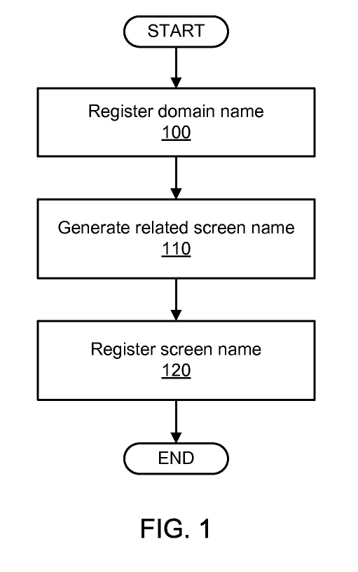

FIG. 1 illustrates a streamlined embodiment of a domain name-based screen name generation and registration method that may comprise the steps of registering a domain name to a registrant (Step 100), generating a software application screen name (perhaps based upon the domain name) (Step 110), and registering the screen name to the registrant (Step 120).

As a non-limiting example, the method illustrated in FIG. 1 (and all methods described herein) may be performed by any central processing unit (CPU) in any computing system, such as a microprocessor running on at least one server, and executing instructions stored (perhaps as scripts and/or software) in computer-readable media accessible to the CPU, such as a hard disk drive on a server. The server(s) may be communicatively coupled to a network (such as the Internet) and at least one client that, collectively (along with the software described herein), may allow a registrant to register domain names and screen names.

Such servers could comprise any computer or program that provides services to other computers, programs, or users either in the same computer or over a computer network. As non-limiting examples, servers may comprise application, communication, mail, database, proxy, fax, file, media, web, peer-to-peer, standalone, software, or hardware servers (i.e., server computers) and may use any server format known in the art or developed in the future (possibly a shared hosting server, a virtual dedicated hosting server, a dedicated hosting server, a could hosting solution, a grid hosting solution, or any combination thereof). Clients that may be used to connect to the network to use the illustrated embodiments may include a desktop computer, a laptop computer, a hand held computer, a terminal, a television, a television set top box, a cellular phone, a wireless phone, a wireless hand held device, an Internet access device, a rich client, thin client, or any other client functional with a client/server computing architecture.

The example embodiments herein place no limitation on network configuration or connectivity. Thus, as non-limiting examples, the network could comprise the Internet, the public switched telephone network, the global Telex network, computer networks (e.g., an intranet, an extranet, a local-area network, or a wide-area network), wired networks, wireless networks, or any combination thereof. Examples of clients that may be used may include a desktop computer, a laptop computer, a hand held computer, a terminal, a television, a television set top box, a cellular phone, a wireless phone, a wireless hand held device, an Internet access device, a rich client, thin client, or any other client functional with a client/server computing architecture.

Servers and clients may be communicatively coupled to the network via any method of network connection known in the art or developed in the future including, but not limited to wired, wireless, modem, dial-up, satellite, cable modem, Digital Subscriber Line (DSL), Asymmetric Digital Subscribers Line (ASDL), Virtual Private Network (VPN), Integrated Services Digital Network (ISDN), X.25, Ethernet, token ring, Fiber Distributed Data Interface (FDDI), IP over Asynchronous Transfer Mode (ATM), Infrared Data Association (IrDA), wireless, WAN technologies (T1, Frame Relay), Point-to-Point Protocol over Ethernet (PPPoE), and/or any combination thereof.

A domain name may be registered to a registrant (perhaps by one of the above-described servers) (Step 100) by any domain name registration method known in the art or developed in the future, perhaps via a website-enabled domain name purchase and registration system, such as that described in detail above. Alternatively, domain name registration may be accomplished via human to human communication, perhaps via a telephone call or in-person meeting. Domain names may be registered by, as non-limiting examples, any individual or entity including, but not limited to a domain name registry, domain name registrar, hosting provider, and/or software application developer or distributor. The registrant may comprise, as a non-limiting example, any individual or entity including, but not limited to, a person, a business, a governmental institution, an educational institution, a non-profit organization, or a social organization.

A screen name for a software application then may be generated that relates in some manner to the domain name (Step 110), perhaps by software and/or scripts running on a server computer. The screen name may comprise any alphanumeric, ASCII, or other sequence of characters, images, and/or file types used by a software application to identify a user to other users, such as on a social website. The software application may comprise any client-side, server-side, or other software application that utilizes screen names to identify users. As non-limiting examples, the software application may comprise a blog application, micro-blogging application, chat application, forum application, social networking website application, instant messaging application and/or any combination thereof.

A blog (i.e., weblog) application may comprise a hosted website, perhaps maintained by an individual with regular entries of written commentary, or other material such as graphics or video, perhaps related to a particular topic. The ability for blog readers to comment on blog entries in an interactive format is common functionality implemented with many blogs. Both the blogger and readers may be identified in the commentary section by screen names that may be selected and registered, perhaps with the blog application.

A micro-blogging application may comprise a particular type of blogging application that allows users to send brief text (or perhaps small-file-size multimedia) updates to a website to be viewed by Internet users. The content of a micro-blog differs from a traditional blog in that it is typically smaller in actual size and aggregate file size. Such micro-blogs may be submitted by varying means, including website text entry or multimedia file uploads, text messaging, instant messaging, and/or email. As with blogs, micro-bloggers may subscribe to a micro-blogging service (e.g., TWITTER) that may require participants to register a screen name to participate. TWITTER for example, allows users to register screen names called “Twitter Handles” in the following format: @screenname. Continuing with the example from above, John Doe (who works at My Company) may register the screen name (i.e., Twitter Handle) “@johndoe,” while official company micro-blogs may be posted under the screen name “@mycompany.”

An instant messaging application may comprise an instant messaging software application that allows one user to communicate with another over a network in real time. The instant messaging software application may comprise proprietary or third-party (e.g., MICROSOFT OFFICE COMMUNICATOR, JABBER, GTALK, SKYPE, MEEBO, ICQ, YAHOO! MESSENGER, MSN MESSENGER, PIDGIN, and/or AOL INSTANT MESSENGER) systems. Many instant messaging software applications allow users to register a screen name and subsequently generate a contact list by adding other user's screen names to the list. If a user is online, their screen name may be displayed indicating that user may be available for instant messaging. Clicking on a user's name may activate an instant messaging window in which messages may be typed and responses received. User comments are generally identified by the user's screen name.

A chat application may comprise an electronic discussion group software application (i.e., text chat) that allows users to join chat rooms and publicly communicate with many users at the same time. Example chat protocols that may be utilized include, as non-limiting examples, Internet Relay Chat (IRC) and/or eXtensible Messaging and Presence Protocol (XMPP). In many discussion group applications, users may join a pre-existing chat room or create a chat room about any topic. Once in the chat room, users may type messages that other users in the room can read, as well as respond to messages from others. Such Chat applications generally require users to register a screen name to participate. User comments are generally identified by the user's screen name.

A forum application may comprise an online group discussion website application for displaying and managing user-generated content, perhaps relating to a particular topic (or topics). The forum application may allow users to post comments (perhaps in text or multimedia format) regarding the topic(s) and may require Internet users to become members (i.e., register with the application) before being allowed to submit messages (“posts”). The registration process typically comprises age verification and agreement to the forum application's terms of service. Registered members may be assigned (or select) a screen name that may be displayed with the user's submitted post. Forum applications may be available for implementation on a website via the Internet and may be written in a variety of programming languages, such as PHP, Perl, Java, and/or ASP.

As described in detail above, a social website application may comprise social networking services that focus on building and verifying online social networks for communities of people who may share interests and activities, wish to communicate with each other efficiently, and may be interested in exploring the interests and activities of others, and which necessitates the use of software applications. A social networking website application may implement one, some, or all of the above-described software applications and may use a common screen name for some or all communications transmitted via the social website application. FACEBOOK, MYSPACE, and LINKEDIN are a few well-known examples of social website applications. FACEBOOK, for example, allows users to register a screen name (i.e., “Facebook username”) that may be associated with some or all FACEBOOK content and/or communications.

When a screen name for any such software application is generated (Step 110), it may be based upon the domain name registered to the registrant in Step 100. Accordingly, the screen name may include—in whole or in part—the domain name. For example, continuing with the example from above, John Doe (who works at My Company) may register the domain name “mycompany.com” (Step 100). A screen name (i.e., Twitter Handle) then may be generated that includes the domain name (i.e., @mycompany.com) (Step 110).

Alternatively, the generated screen name could comprise a suggested variant of the domain name. The suggested screen name may relate in some way to the originally-registered domain name and may be generated by any domain name suggestion software known in the art or developed in the future including, but not limited to, open-source or commercially-available domain name suggestion applications such as DOMAINSBOT or NAMETUMBLER. Alternatively, proprietary applications may be used. Such software may, as a non-limiting example, parse a character string (e.g., domain name or screen name) into keywords, find similar alternates to the keywords, and recombine the alternate keywords into a suggested domain name or screen name (or other character string as required by the specific application). Continuing with the example from above, suggested variants of the domain name “mycompany.com,” such as “yourcompany.com” or “mybusiness.com” may be generated and used as a screen name (e.g., @yourcompany.com or @mybusiness.com in the TWITTER example).

As a non-limiting example, the domain name suggestion applications described in detail in U.S. patent application Ser. Nos. 12/468,326, 12/468,313, 12/395,308, 12/395,262, 12/395,228, 12/328,616, 12/328,601, and/or 12/055,881 may be utilized, all of which are assigned to The Go Daddy Group, Inc. and hereby incorporated by reference in their entirety.

The illustrated embodiments place no limitation on the format the domain name may take. While future iterations of the DNS may establish alternate domain name formats (perhaps using different alphanumeric structures or file types such as image, audio, or video files functioning as a domain name or a similarly-functioning resource locator), which are explicitly contemplated by this patent application, the traditional domain name structure comprises a root name (i.e., “mycompany” in the domain name mycompany.com) concatenated to a top-level domain (i.e., “.com” in the domain name mycompany.com). In this construct, a generated screen name may comprises only the root name (e.g., @mycompany) or a suggested variant of the root name (e.g., @yourcompany or @mybusiness).

During the domain name registration process (Step 100), various information may be provided by the domain name registrant. As a non-limiting example, the registrant's name, address, business name, email address, website URL, etc. may be provided. Any such information also may be used as a basis to generate a screen name. Thus, if John Doe provided his name while registering the domain name mycompany.com, a screen name such as @johndoe may be generated.

The screen name then may be registered to the registrant (Step 120). This step may be accomplished, perhaps by the above-described software applications themselves or other software and/or scripts running on a server computer, by assigning the screen name to the exclusive use of the registrant within the functionality of the software application. The registered screen name, perhaps along with identifying information about the registrant (e.g., name, address, business name, email address, website URL, etc.) may be stored in a screen name database that may be communicatively coupled to a network for accessibility. Such a database (and any other database described herein) may comprise, as non-limiting examples, a local database, online database, desktop database, server-side database, relational database, hierarchical database, network database, object database, object-relational database, associative database, concept-oriented database, entity-attribute-value database, multi-dimensional database, semi-structured database, star schema database, XML database, file, collection of files, spreadsheet, or other means of data storage located on a computer, client, server, or any other storage device known in the art or developed in the future.

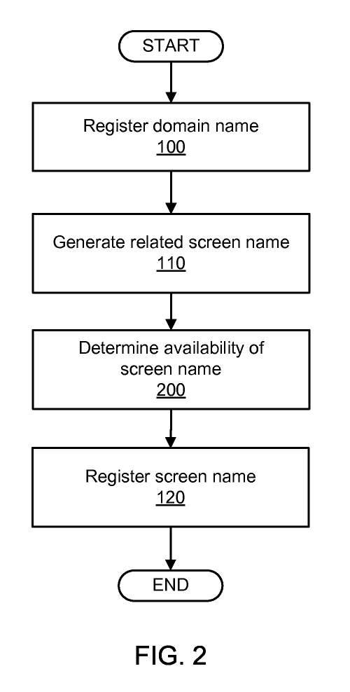

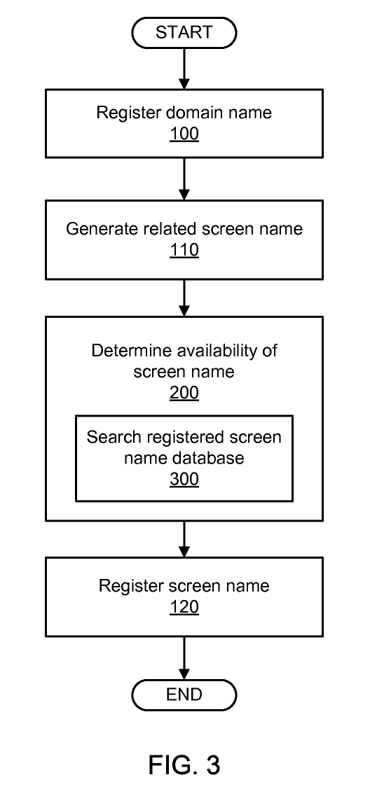

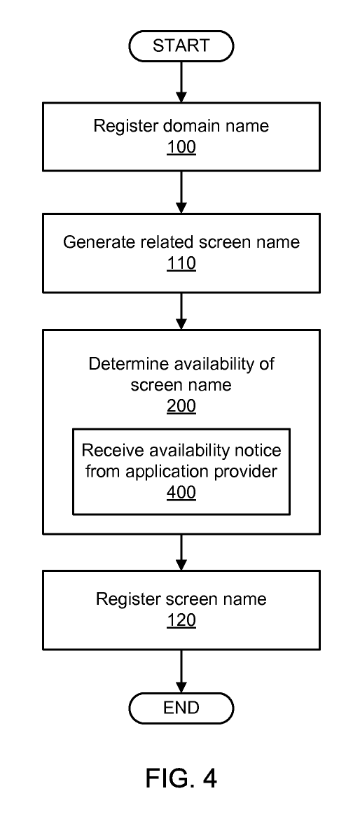

FIG. 2 builds upon the method illustrated in FIG. 1 by adding the step of, prior to registering the screen name (Step 120), determining that the generated screen name is available for registration (Step 200). Screen name availability may be determined by any method known in the art or developed in the future of determining whether a screen name has already been registered including, but not limited to (as shown in FIG. 3) searching a screen name database storing a plurality of registered screen names (Step 300). Alternatively, and as shown in FIG. 4, screen name availability may be determined by receiving notice from a software application (and/or its provider) whether a screen name is available for registration (Step 400). Such notice may comprise any electronic response received (perhaps at a server computer responsive to a request sent in kind) including, but not limited to, a Hyper Text Transfer Protocol (HTTP) request, email message, and/or Short Message Service (SMS) message (i.e., text message). Notice also may be received via paper mail, telephone conversation, person to person contact, or any other means for receiving screen name availability notice known in the art or developed in the future.

As another non-limiting example, a software application provider, such as TWITTER, may provide an Applications Programming Interface (API), perhaps accessible via the network, that may receive screen name (i.e., Twitter handle) availability requests and may provide responsive notice of availability. An API is a software-to-software interface that specifies the protocol defining how independent computer programs interact or communicate with each other. The API may allow a requesting party's software to communicate and interact with the software application and/or its provider—perhaps over the network—through a series of function calls (requests for services). It may comprise an interface provided by the software application and/or its provider to support function calls made of the software application by other computer programs, perhaps those utilized by the requesting party to determine screen name availability. The API may comprise any API type known in the art or developed in the future including, but not limited to, request-style, Berkeley Sockets, Transport Layer Interface (TLI), Representational State Transfer (REST), SOAP, Remote Procedure Calls (RPC), Standard Query Language (SQL), file transfer, message delivery, and/or any combination thereof.

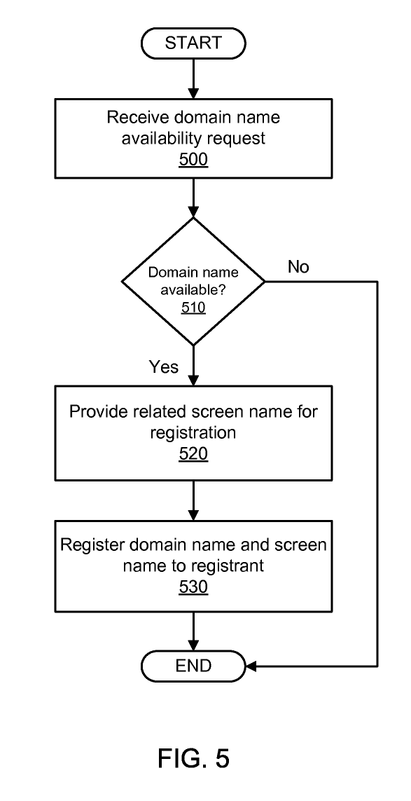

FIG. 5 illustrates another embodiment of a domain name-based screen name generation and registration method. The illustrated method may comprise the step of receiving, by at least one server computer communicatively coupled to a network, a request to determine the availability of a domain name for registration (Step 500). The request may come from any individual or entity having access to the network that may wish to research potential domain names for registration and may comprise any electronic request received by the server including, but not limited to, a Hyper Text Transfer Protocol (HTTP) request, email message, and/or Short Message Service (SMS) message (i.e., text message). The request may comprise any combination of data seeking information relating to domain name availability. The request may or may not include a keyword, search term, or requested domain name. As non-limiting examples, the request may comprise an HTTP request initiated by a potential registrant on a domain name registrar's website, perhaps by entering a requested domain name in a data field and clicking a button entitled “search for available domain names.” Alternatively, a list of possible domain names may be provided on the website. The request may be generated when a potential registrant selects at least one domain name on which to perform an availability check.

The registration availability of the domain name then may be determined (Step 510), perhaps by at least one server ascertaining whether the domain name (e.g., “mycompany.com”) has already been registered by checking the SRS database associated with the TLD of the domain name (.com in the instant example). As an additional non-limiting example, any of the systems and/or methods may be used as described in U.S. Patent Application Publication No. 2004-0199520, which is assigned to The Go Daddy Group, Inc. and incorporated herein by reference. Alternatively, any method of determining domain name registration availability known in the art or developed in the future may be used.

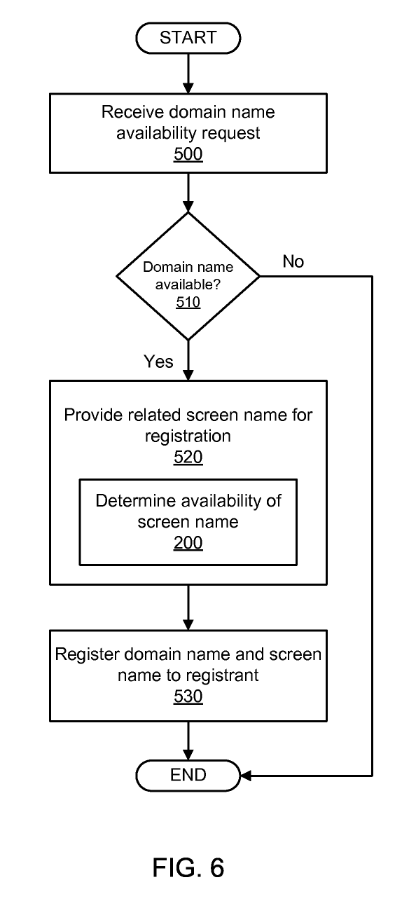

Responsive to a determination that the domain name is available for registration, an available screen name for a software application (that may be based upon the domain name) may be provided for registration, perhaps by software and/or scripts running on at least one server computer (Step 520). This step may be accomplished by any method of informing a potential registrant that a screen name may be available for registration. As a non-limiting example, where a request for domain name availability is received (Step 500) via an electronic request (e.g., HTTP request, email message, SMS message, text message), the related screen name may be provided for registration (Step 520) via similar electronic communication means, perhaps via a server. Thus, an HTTP domain name request may be responded to with an HTTP response that provides (in addition to notification that the requested domain name is available) a webpage listing a related screen name for registration, perhaps as a hyperlink. FIG. 6 illustrates that Step 520 may include the step of determining the availability of the provided screen name (Step 200), which may be accomplished as described in detail above with respect to Steps 200, 300, and 400.

Returning to FIG. 5, both the available domain name and the available related screen name then may be registered to the registrant (Step 530). Domain name registration may be accomplished by any domain name registration method known in the art or developed in the future, perhaps via a website-enabled domain name purchase and registration system, such as that described in detail above. Alternatively, domain name registration may be accomplished via human to human communication, perhaps via a telephone call or in-person meeting. Domain names may be registered by, as non-limiting examples, any individual or entity including, but not limited to a domain name registry, domain name registrar, domain name registrar, hosting provider, and/or software application developer or distributor. Screen name registration may be accomplished as described above with respect to Step 120.

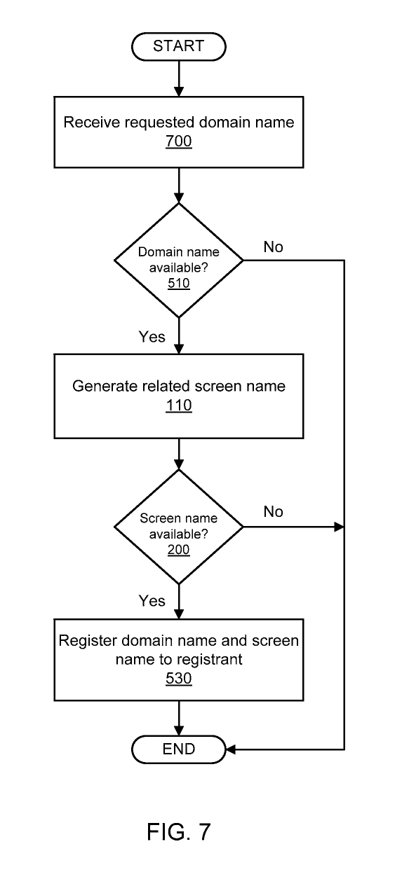

FIG. 7 illustrates a more detailed embodiment of a domain name-based screen name generation and registration method. The illustrated method may comprise the step of receiving, perhaps by at least one server computer communicatively coupled to a network, a requested domain name (Step 700). This step may be accomplished in the same manner as Step 500, except that only a requested domain name is received. The registration availability of the domain name then may be determined (Step 510) and, responsive to a determination that the domain name is available for registration, an available software application screen name (that may be based upon the domain name) may be generated (Step 110). The screen name's registration availability then may be determined (Step 200) and, responsive to a determination that the screen name is available, both the screen name and the domain name may be registered to the registrant (Step 530).

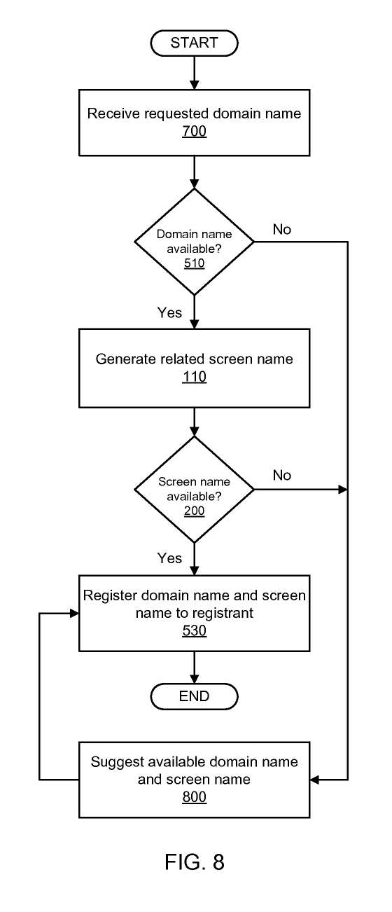

FIG. 8 builds upon the method illustrated in FIG. 7 by adding the step of, responsive to a determination that either the domain name or the screen name are not available for registration, suggesting (perhaps by software and/or scripts running on at least one server computer) at least one alternate available domain name and at least one alternate available screen name for registration (Step 800). In one example embodiment, the alternate domain name may relate to the original domain name and may be suggested by any of the domain name suggestion tools and/or methods described in detail above. The suggested alternate screen name may relate to the alternate domain name, and may be generated as described above with respect to Step 110.

Methods for Generating and Registering Screen Name-Based Domain Names

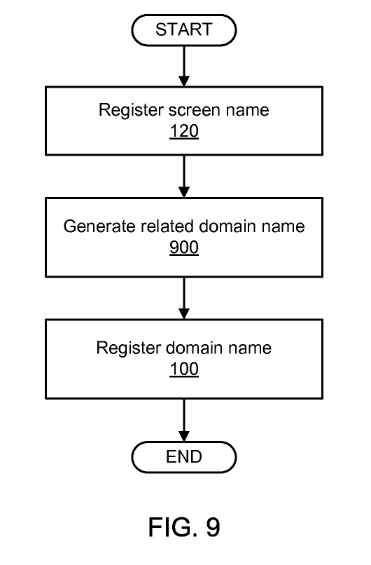

FIG. 9 illustrates a streamlined embodiment of a method for generating and registering domain names that may be based upon screen names. The illustrated method may comprise registering a screen name for a software application to a registrant (Step 120) as described in detail above. A domain name (perhaps based upon the screen name) then may be generated. Accordingly, the domain name may include—in whole or in part—the screen name. For example, continuing with the example from above, John Doe (who works at My Company) may register the screen name (e.g., Twitter Handle) “@johndoe” or “@mycompany.” A domain name then may be generated that includes the screen name (i.e., “johndoe.com” or “mycompany.com”) (Step 900).

Alternatively, the generated domain name could comprise a suggested variant of the screen name. The domain name may relate in some way to the originally-registered domain name and may be generated by any domain name suggestion software known in the art or developed in the future including, but not limited to, open-source or commercially-available domain name suggestion applications such as DOMAINSBOT or NAMETUMBLER. Alternatively proprietary applications may be used. As a non-limiting example, the domain name suggestion applications described in detail in U.S. patent application Ser. Nos. 12/468,326, 12/468,313, 12/395,308, 12/395,262, 12/395,228, 12/328,616, 12/328,601, and/or 12/055,881 may be utilized, all of which are assigned to The Go Daddy Group, Inc. and hereby incorporated by reference in their entirety. Continuing with the example from above, suggested variants of the screen name “@mycompany.com,” such as “@yourcompany.com” or “@mybusiness.com” may be generated and used as a domain name (e.g., yourcompany.com or mybusiness.com).

During the screen name registration process (Step 120), various information may be provided by the screen name registrant. As a non-limiting example, the registrant's name, address, business name, email address, website URL, etc. may be provided. Any such information also may be used as a basis to generate a domain name. Thus, if John Doe provided his name while registering the screen name (Twitter handle) @mycompany, a domain name such as johndoe.com may be generated. The generated domain name then may be registered to the registrant (Step 100) as described in detail above.

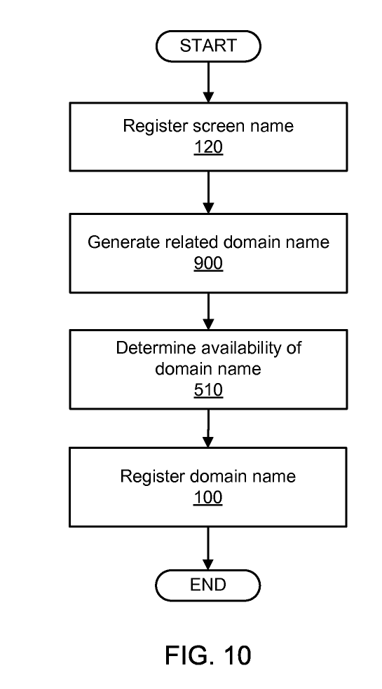

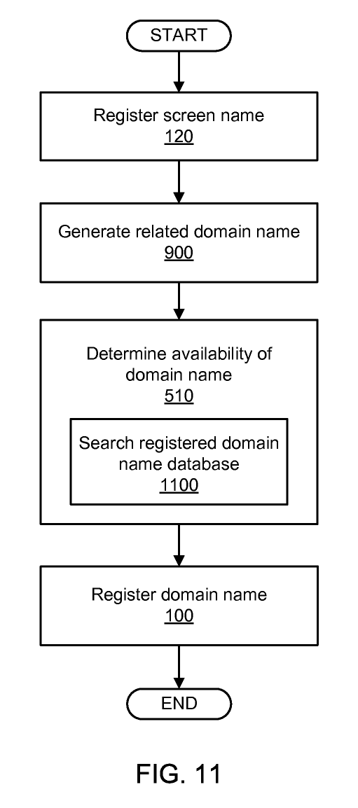

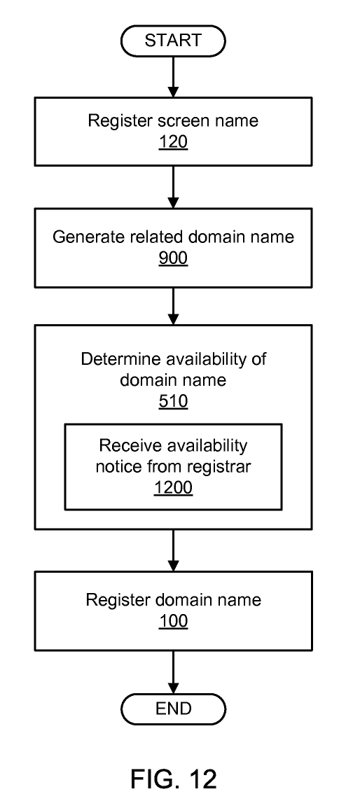

FIG. 10 builds upon the method illustrated in FIG. 9 by adding the step of, prior to registering the domain name (Step 110), determining that the generated domain name is available for registration (Step 510) as described in detail above. Domain name availability also may be determined (as shown in FIG. 11) by searching a domain name database storing a plurality of registered domain names (Step 1100). Alternatively, and as shown in FIG. 12, domain name availability may be determined by receiving notice from a domain name registrar (or other domain name provider) whether a domain name is available for registration (Step 1200). Such notice may comprise any electronic response received (perhaps at a server computer responsive to a request sent in kind) including, but not limited to, a Hyper Text Transfer Protocol (HTTP) request, email message, and/or Short Message Service (SMS) message (i.e., text message). Notice also may be received via paper mail, telephone conversation, person to person contact, or any other means for receiving screen name availability notice known in the art or developed in the future. As another non-limiting example, a domain name registrar (or other domain name provider) may provide an exposed API (perhaps accessible via a network) that may receive domain name availability requests and may provide responsive notice of availability.

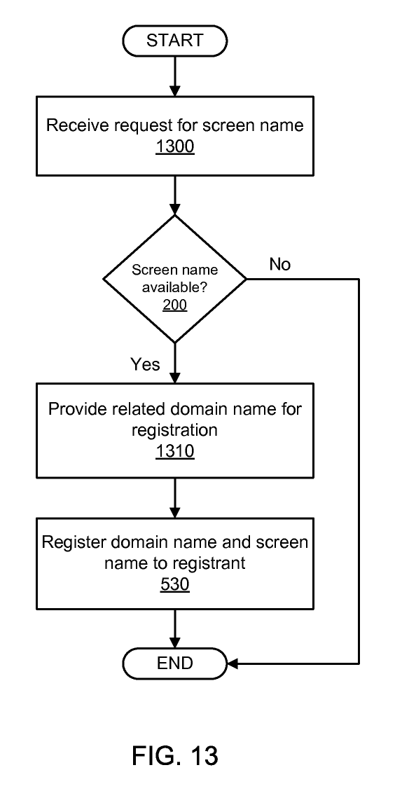

FIG. 13 illustrates an alternate embodiment of a method for generating and registering domain names that may be based upon screen names. The illustrated method may comprise receiving a request for a screen name for a software application (Step 1500). The request may come from any individual or entity that may wish to research potential screen names for registration and may comprise any electronic request received (perhaps by a server running the software application) including, but not limited to, a Hyper Text Transfer Protocol (HTTP) request, email message, and/or Short Message Service (SMS) message (i.e., text message). The request may comprise any combination of data seeking information relating to screen name availability. The request may or may not include a keyword, search term, or requested screen name. As non-limiting examples, the request may comprise an HTTP request initiated by a software application user's browser, perhaps by entering a screen name in a data field of a social networking website and clicking a button entitled “search for available screen names.” Alternatively, a list of possible screen names may be provided on the website. The request may be generated when a potential registrant selects at least one screen name on which to perform an availability check.

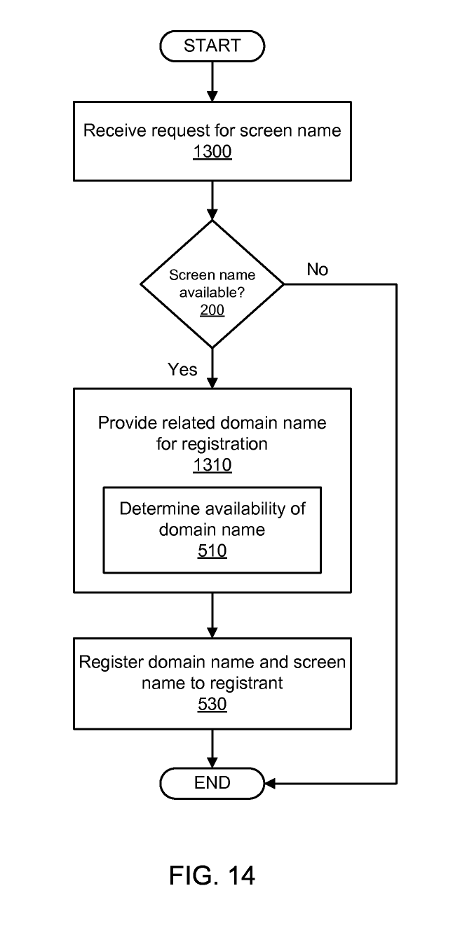

Screen name availability then may be determined as described in detail above (Step 200). If available, a domain name relevant to the screen name may be generated, perhaps as described above with respect to Step 900 and provided for registration (Step 1310). This step may be accomplished by any method of informing a potential registrant that a domain name may be available for registration. As a non-limiting example, where a request for screen name availability is received (Step 1300) via an electronic request (e.g., HTTP request, email message, SMS message, text message), the related domain name may be provided for registration (Step 1310) via similar electronic communication means, perhaps via a server. Thus, an HTTP screen name request may be responded to with an HTTP response that provides (in addition to notification that the requested screen name is available) a webpage listing a related domain name for registration, perhaps as a hyperlink. FIG. 14 illustrates that Step 1310 may include the step of determining the availability of the provided domain name (Step 510), which may be accomplished as described in detail above. Returning to FIG. 13, both the available domain name and the available related screen name then may be registered to the registrant (Step 530) via the methods described in detail above.

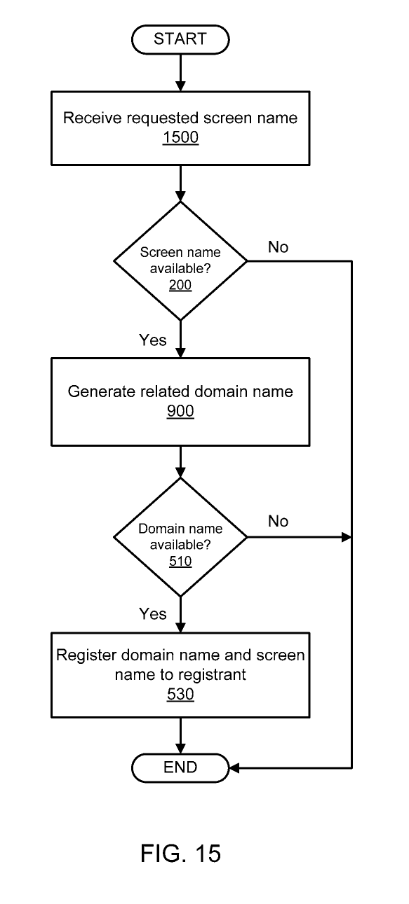

FIG. 15 illustrates an alternate embodiment comprising the steps of receiving a requested software application screen name (Step 1500), determining whether the screen name is available for registration (Step 200), generating (responsive to a determination that the screen name is available) a domain name that may be based upon the screen name (Step 900), determining whether the domain name is available for registration (Step 510), and registering (responsive to a determination that domain name is available) both the domain name and the screen name to a registrant (Step 530).

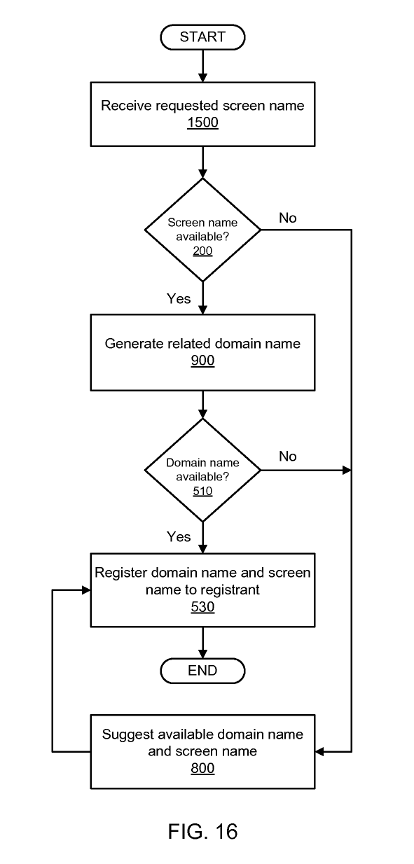

FIG. 16 builds upon the method illustrated in FIG. 15 by adding the step of, responsive to a determination that either the domain name or the screen name are not available for registration, suggesting (perhaps by software and/or scripts running on at least one server computer) at least one alternate available domain name and at least one alternate available screen name for registration (Step 800).

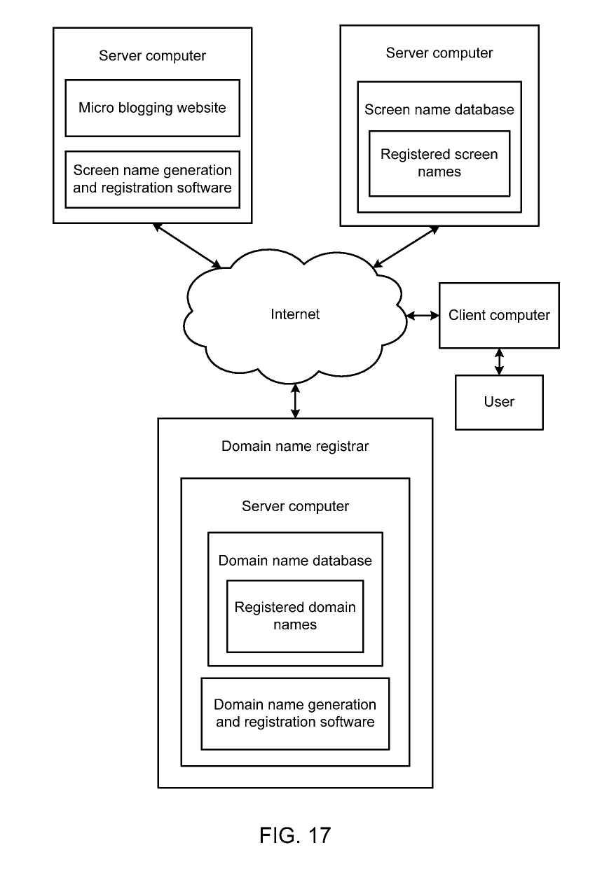

FIG. 17 illustrates a non-limiting embodiment of one of numerous systems that may be used to implement the methods described herein.

Other embodiments and uses of the above inventions will be apparent to those having ordinary skill in the art upon consideration of the specification and practice of the inventions disclosed herein. The specification and examples given should be considered exemplary only, and it is contemplated that the appended claims will cover any other such embodiments or modifications as fall within the true scope of the inventions.

The Abstract accompanying this specification is provided to enable the United States Patent and Trademark Office and the public generally to determine quickly from a cursory inspection the nature and gist of the technical disclosure and in no way intended for defining, determining, or limiting the present inventions or any of its embodiments.

The inventions claimed are:

1. A method performed by at least one microprocessor on at least one server computer executing a plurality of instructions stored on at least one computer-readable media, said method comprising the steps of:
A) registering, by at least one server computer communicatively coupled to a network, a domain name to a registrant;
B) generating, by said at least one server computer, a screen name for a software application, said screen name being based upon said domain name; and
C) registering, by said at least one server computer, said screen name to said registrant.

2. The method of claim 1, wherein said screen name comprises said domain name.

3. The method of claim 1, wherein said screen name comprises a suggested variant of said domain name.

4. The method of claim 1, wherein said domain name comprises a root name concatenated to a top-level domain.

5. The method of claim 4, wherein said screen name comprises said root name.

6. The method of claim 4, wherein said screen name comprises a suggested variant of said root name.

7. The method of claim 4, wherein said screen name is based upon at least one information provided by said registrant during a domain name registration process.

8. The method of claim 1, wherein said software application comprises a client-side software application.

9. The method of claim 1, wherein said software application comprises a server-side software application.

10. The method of claim 1, wherein said software application is selected from the group consisting of a micro-blogging application, a chat application, a forum application, a social networking application, a blog application, and an instant messaging application.

11. The method of claim 1, further comprising the step of determining that said screen name is available for registration.

12. The method of claim 11, wherein said determining step further comprises the step of receiving notice from a provider of said software application whether said screen name is available for registration.

13. The method of claim 11, wherein said determining step further comprises the step of searching a screen name database storing a plurality of registered screen names.

14. The method of claim 1, wherein said network comprises the Internet.

15. A method performed by at least one microprocessor on at least one server computer executing a plurality of instructions stored on at least one computer-readable media, said method comprising the steps of:
A) receiving, by at least one server computer communicatively coupled to a network, a request to determine the availability of a domain name for registration;
B) responsive to a determination that said domain name is available for registration, providing for registration, by said at least one server computer, an available screen name for a software application, said screen name being based upon said domain name; and
C) registering, by said at least one server computer, said domain name and said screen name to said registrant.

16. The method of claim 15, wherein said screen name comprises said domain name.

17. The method of claim 15, wherein said screen name comprises a suggested variant of said domain name.

18. The method of claim 15, wherein said domain name comprises a root name concatenated to a top-level domain.

19. The method of claim 18, wherein said screen name comprises said root name.

20. The method of claim 18, wherein said screen name comprises a suggested variant of said root name.

21. The method of claim 18, wherein said screen name is based upon at least one information provided by said registrant during a domain name registration process.

22. The method of claim 15, wherein said software application comprises a client-side software application.

23. The method of claim 15, wherein said software application comprises a server-side software application.

24. The method of claim 15, wherein said software application wherein said software application is selected from the group consisting of a micro-blogging application, a chat application, a forum application, a social networking application, a blog application, and an instant messaging application.

25. The method of claim 15, wherein said providing step B) further comprises the step of determining whether said screen name is available for registration.

26. The method of claim 25, wherein said determining step further comprises the step of receiving notice from a provider of said software application whether said screen name is available for registration.

27. The method of claim 25, wherein said determining step further comprises the step of searching a screen name database storing a plurality of registered screen names.

28. The method of claim 15, wherein said network comprises the Internet.

29. A method performed by at least one microprocessor on at least one server computer executing a plurality of instructions stored on at least one computer-readable media, said method comprising the steps of:
A) receiving, by at least one server computer communicatively coupled to a network, a requested domain name;
B) determining, by said at least one server computer, whether said domain name is available for registration;
C) responsive to a determination that said domain name is available for registration, generating, by said at least one server computer, a screen name for a software application, said screen name being based upon said domain name;
D) determining, by said at least one server computer, whether said screen name is available for registration; and
E) responsive to a determination that said screen name is available for registration, registering, by said at least one server computer, both said domain name and said screen name to a registrant.

30. The method of claim 29, further comprising the step of:
F) responsive to a determination that either said domain name or said screen name are not available for registration, suggesting, by said at least one server computer, at least one alternate available domain name and at least one alternate available screen name for registration.

31. The method of claim 29, wherein said screen name comprises said domain name.

32. The method of claim 29, wherein said screen name comprises a suggested variant of said domain name.

33. The method of claim 29, wherein said domain name comprises a root name concatenated to a top-level domain.

34. The method of claim 33, wherein said screen name comprises said root name.

35. The method of claim 33, wherein said screen name comprises a suggested variant of said root name.

36. The method of claim 29, wherein said screen name is based upon at least one information provided by said registrant during a domain name registration process.

37. The method of claim 29, wherein said software application comprises a client-side software application.

38. The method of claim 29, wherein said software application comprises a server-side software application.

39. The method of claim 29, wherein said software application, wherein said software application is selected from the group consisting of a micro-blogging application, a chat application, a forum application, a social networking application, a blog application, and an instant messaging application.

40. The method of claim 29, wherein said alternate domain name and said alternate screen name are based upon said domain name.

41. The method of claim 29, wherein said network comprises the Internet.
